(19) United States
(12) Patent Application Publication
(10) Pub. No.: US 2015/0283895 A1
(43) Pub. Date: Oct. 8, 2015

(54) RADIATOR AND VEHICLE EQUIPPED WITH THE RADIATOR

(71) Applicant: TOYOTA JIDOSHA KABUSHIKI KAISHA, Toyota-shi (JP)

(72) Inventor: Yuki TAKAHASHI, Okazaki-shi (JP)

(73) Assignee: TOYOTA JIDOSHA KABUSHIKI KAISHA, Toyota-shi (JP)

(21) Appl. No.: 14/635,326

(22) Filed: Mar. 2, 2015

(30) Foreign Application Priority Data
Apr. 7, 2014 (JP) 2014-078550

(51) Int. Cl. B60K 11/04; B60K 6/40

(52) U.S. Cl. CPC B60K 11/04; B60K 6/40; Y10S 903/951; Y10S 903/904

(57) ABSTRACT

A radiator is accommodated in an engine compartment in a front part of a vehicle and configured to dissipate heat of coolant that has circulated in an internal combustion engine. The radiator includes a weak portion, which is weaker against load in the longitudinal direction of the vehicle than the other portions. The radiator is easily compressed and deformed when load in the longitudinal direction of the vehicle is applied compared to a case where the radiator lacks the weak portion.

### BACKGROUND OF THE INVENTION

The present invention relates to a radiator configured to dissipate the heat of coolant circulated in an internal combustion engine, and also relates to a vehicle equipped with the radiator.

The engine compartment of a vehicle has a radiator that dissipates the heat of coolant circulated in the internal combustion engine.

Japanese Laid-Open Patent Publication No. 2012-11977 discloses a radiator support, which supports a radiator. This radiator support has a right upper member and a left upper member. The right and left upper members are connected by a pin. The right and left upper members are pivoted relative to each other around the pin when load is applied to the vehicle from the front. Thereby the radiator support bends in the backward direction of the vehicle. The radiator support is easily bent in the backward direction of the vehicle when the vehicle is involved in a frontal collision. Accordingly, the radiator support is able to ensure an impact absorbing stroke.

### SUMMARY OF THE INVENTION

When the radiator support bends in the rearward direction of the vehicle, the radiator supported by the radiator support is also moved in the backward direction of the vehicle.

The engine compartment accommodates, in addition to the radiator, various components. Therefore, if the radiator moves in the rearward direction of the vehicle, the radiator may interfere with components arranged rearward of the radiator. Such interference may deform components arranged rearward of the radiator, due to load transmitted to them via the radiator.

Such a problem results from interference between the radiator and components arranged rearward of the radiator.

Therefore, as long as the radiator interferes with other components, such a problem is inevitable regardless of whether or not a configuration for actively changing the shape of a radiator support is provided, as in Japanese Laid-Open Patent Publication No. 2012-11977.

The objective of the present invention is to provide a radiator that is able to restrain deformation of components arranged rearward of the radiator, and to provide a vehicle equipped with the radiator.

To achieve the foregoing objective and in accordance with one aspect of the present invention, a radiator is provided that is accommodated in an engine compartment in a front part of a vehicle and configured to dissipate heat of coolant that has circulated in an internal combustion engine. The radiator includes a weak portion, which is weaker against load in a longitudinal direction of the vehicle than the other portions. The radiator is easily compressed and deformed when receiving load in the longitudinal direction of the vehicle compared to a case where the radiator lacks the weak portion.

In accordance with another aspect of the present invention, a vehicle is provided that includes the above described radiator. The vehicle further includes a motor and an inverter for controlling the motor. The internal combustion engine and the motor are used as sources of driving force. The inverter is located rearward of the radiator in the engine compartment.

Other aspects and advantages of the invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a schematic diagram showing the inside of the engine compartment of a vehicle equipped with a radiator according to a first embodiment;

FIG. 2 is a perspective view of the radiator in FIG. 1;

FIG. 3 is a front view of the reservoir tank in FIG. 2;

FIG. 4 is a top view of the reservoir tank in FIG. 2;

FIG. 5 is a left side view of the reservoir tank in FIG. 2;

FIG. 6 is a cross-sectional view taken along line 6-6 in FIG. 5;

FIG. 7 is a schematic diagram showing a state of the inside of the engine compartment when load is applied from the front to the vehicle in FIG. 1;

FIG. 8 is a cross-sectional view showing a modification of the reservoir tank in FIG. 7;

FIG. 9 is a cross-sectional view showing a modification of a reservoir tank provided in a radiator according to a second embodiment;

FIG. 10 is a perspective view showing a reservoir tank provided in a radiator according to another embodiment;

FIG. 11 is a perspective view showing a reservoir tank provided in a radiator according to another embodiment; and

FIG. 12 is a perspective view showing a reservoir tank provided in a radiator according to another embodiment.

### DETAILED DESCRIPTION OF THE PREFERRED EMBODIMENTS

### First Embodiment

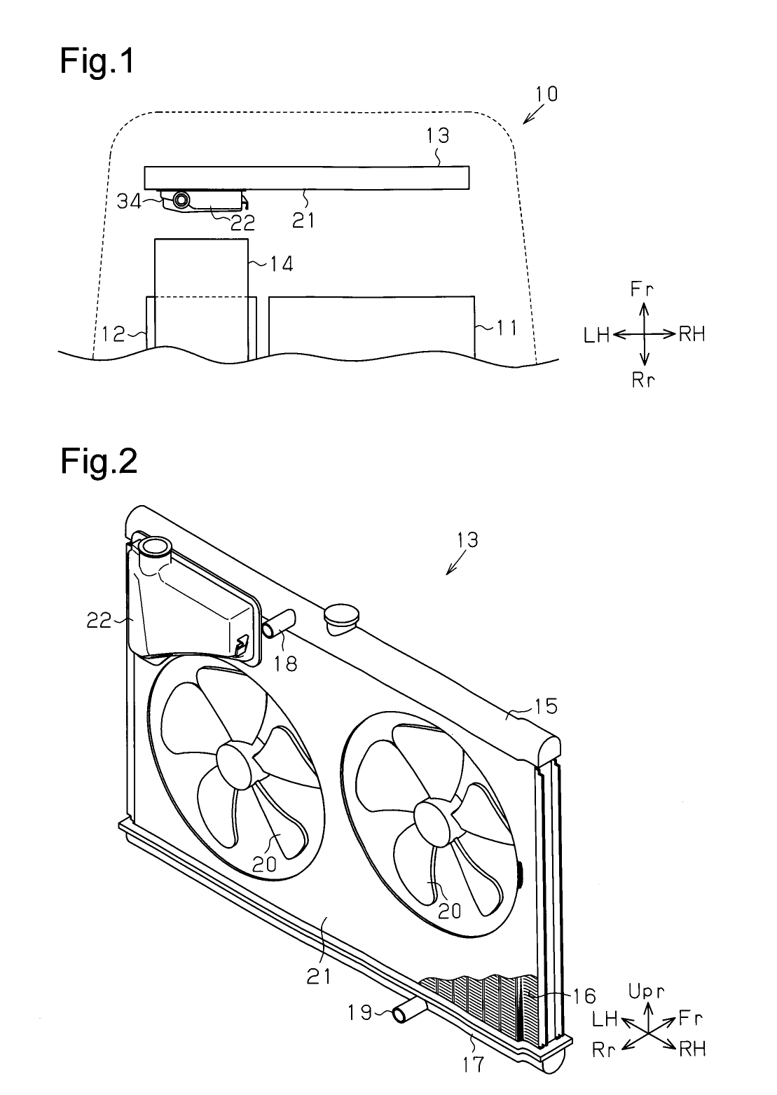

A radiator and a vehicle equipped with the radiator according to a first embodiment will be described below with reference to FIGS. 1 to 8. In the description below, terms “forward,” “rearward,” “upward,” “downward” and the like are directions in relation to a vehicle. In each drawing, for directions in relation to the vehicle, a forward direction is represented by “Fr” a rearward direction is represented by “Rr” a right hand direction when facing forward is represented by “RH” a left hand direction when facing forward is represented by “LH;” and an upper direction is represented by “Upr.”

As shown in FIG. 1, an engine compartment 10 provided in the front of the vehicle accommodates an internal combustion engine 11 and a motor 12, as the sources of driving force, and a radiator 13. Coolant circulates within the internal combustion engine 11. Coolant that has circulated in the internal combustion engine 11 is supplied to the radiator 13. The radiator 13 is supported on the vehicle via a radiator support. The engine compartment 10 also accommodates an inverter 14 that controls the motor 12. The inverter 14 is arranged rearward of the radiator 13. As shown in FIG. 1, the space between the radiator 13 and the internal combustion engine 11 is relatively wide. In contrast, the space between the radiator 13 and the inverter 14 is relatively narrow.

As shown in FIG. 2, the radiator 13 includes an upper tank 15, into which coolant that has circulated in the internal combustion engine 11 flows, a radiator core 16 connected to the lower part of the upper tank 15 and through which air passes, and a lower tank 17 connected to the lower part of the radiator core 16. An inlet 18, into which coolant flows, is formed in the upper tank 15, and an outlet 19, from which coolant flows out, is formed in the lower tank 17. Coolant supplied to the radiator 13 is supplied to the upper tank 15 through the inlet 18, passed through the radiator core 16 and lower tank 17 in that order, and then returned into the internal combustion engine 11 through the outlet 19. When the coolant passes through the radiator core 16, heat is exchanged between the coolant and air, thereby dissipating the heat of the coolant.

Electric radiator fans 20 are provided rearward of the radiator core 16. The rear portion of the radiator core 16 is covered with a fan shroud 21. Such a radiator 13 drives the radiator fans 20, thereby sending a current of air rearward and increasing the quantity of air passed through the radiator core 16, thus accelerating dissipation of the heat of the coolant.

Additionally, as shown in the left upper part of FIG. 2, the radiator 13 has a reservoir tank 22, made of plastic, which stores coolant. As shown in FIG. 1, the reservoir tank 22 is located in the rearmost part of the radiator 13.

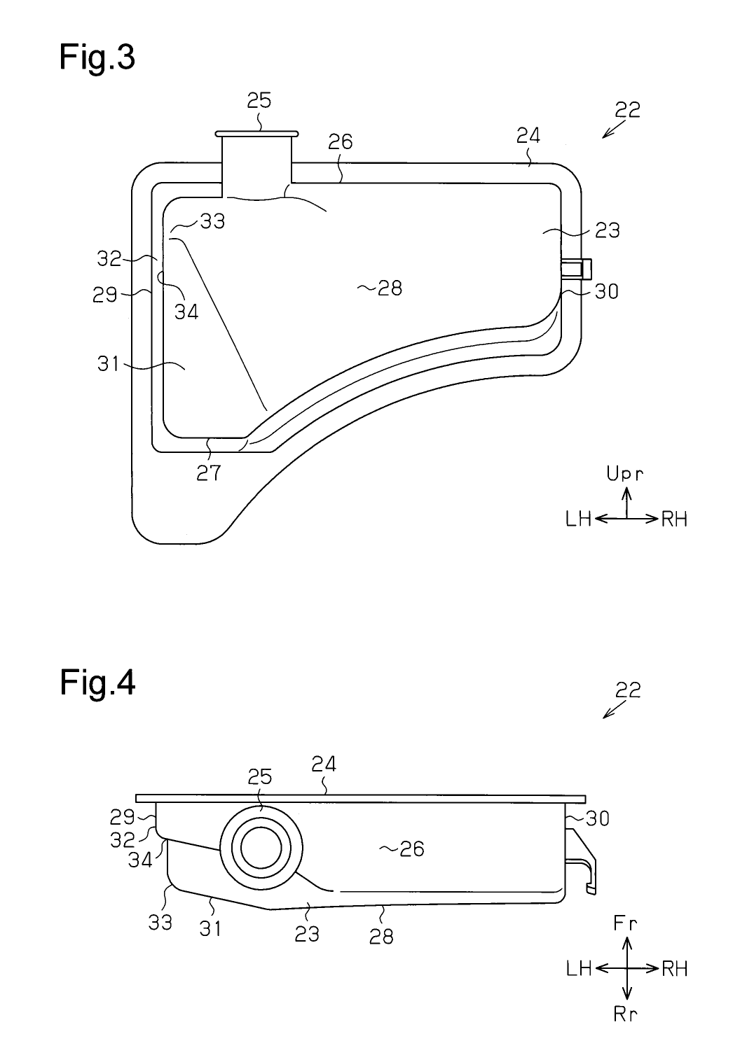

With reference FIGS. 3 to 6, the reservoir tank 22 will be described.

As shown in FIG. 3, the reservoir tank 22 has a storage portion 23 for storing coolant and a flange portion 24 extending outward from the storage portion 23. The flange portion 24 is fixed to the upper tank 15 and the fan shroud 21 by, for example, welding. The storage portion 23 has the shape of a hollow box, and, as shown in FIG. 3, it is substantially trapezoidal as viewed from the front. The storage portion 23 includes an upper wall 26, to which a tank cap 25 is attached, a lower wall 27 opposite to the upper wall 26, a left side wall 29 located on the left hand side, a right side wall 30 located on the right hand side, and a rear wall 28. The rear wall 28 is connected to the flange portion 24 via the upper wall 26, lower wall 27, left side wall 29, and a right side wall 30.

As shown in FIG. 4, the portion of the rear wall 28 closer to the left side wall 29 has an inclined face 31, which is inclined such that it is located further forward as the distance from the left side wall 29 decreases.

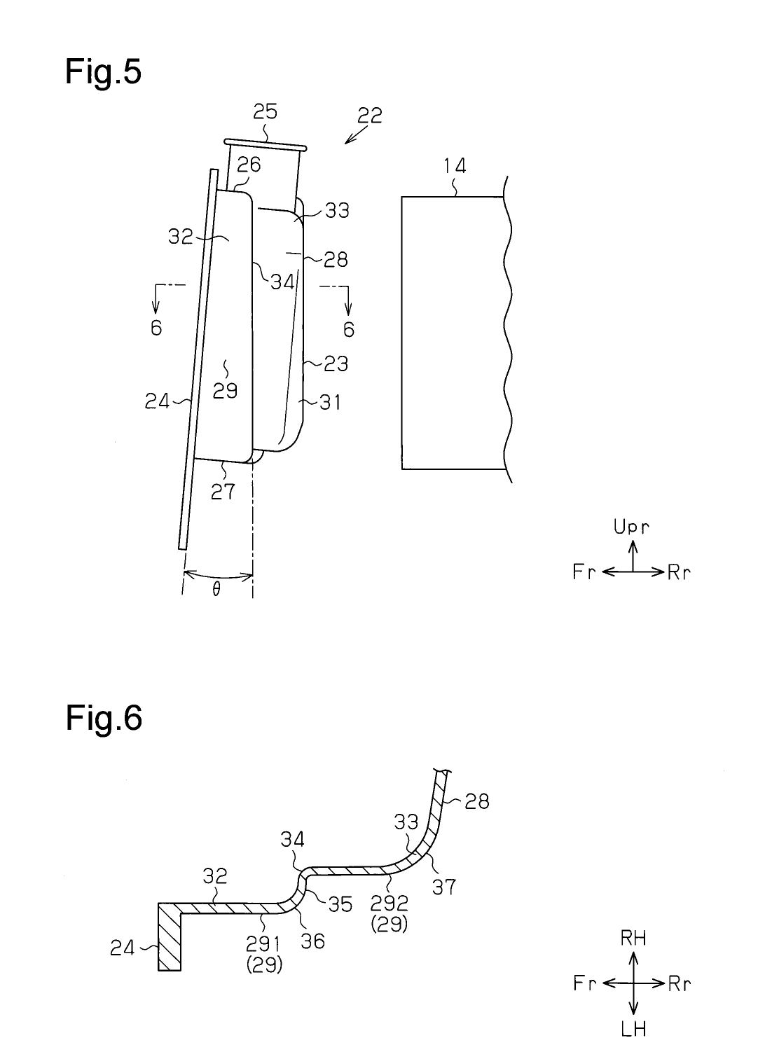

Additionally, as shown in FIGS. 5 and 6, the left side wall 29 of the reservoir tank 22 includes a connection portion 34 having a bent face, a front portion 32 located forward of the connection portion 34, and a rear portion 33 located rearward of the connection portion 34. The connection portion 34, i.e., the bent face connects the front portion 32 and rear portion 33 such that there is a step between them. To be specific, as shown in FIG. 6, the front portion 32 includes a front left side wall 291 of the left side wall 29, and the rear portion 33 includes a rear left side wall 292. A face 35 extending toward the interior of the reservoir tank 22 from the rear end of the front left side wall 291 is connected to the rear left side wall 292 by the connection portion 34. In the reservoir tank 22, the rear portion 33 is narrower than the front portion 32 in the lateral direction of the vehicle.

The front portion 32 has a corner 36, and the rear portion 33 has a corner 37. The connection portion 34 is smaller in radius of curvature than the corners 36, 37. Additionally, the corner 36 is smaller in radius of curvature than the corner 37. That is, the radius of curvature of the connection portion 34 is the smallest. The radius of curvature increases in the following order: the connection portion 34, the corner 36, and the corner 37.

The thickness of the corner 37 of the rear portion 33 becomes gradually thinner toward the connection portion 34.

Therefore, the thickness of the rear left side wall 292 is less than that of the rear wall 28. Also, the thickness of the corner 36 of the front portion 32 becomes gradually thinner toward the connection portion 34. Therefore, the thickness of the face 35 connected to the connection portion 34 is less than that of the front left side wall 291. The thickness of the front left side wall 291 is substantially identical to that of the rear wall 28. That is, the connection portion 34 and the surrounding parts thereof are thinner than the other portions.

As with the left side wall 29 provided with the connection portion 34, the upper wall 26 and lower wall 27 are also respectively provided with a bent connection portion.

Additionally, as shown in FIG. 5, the reservoir tank 22 is accommodated in the engine compartment 10 such that the flange portion 24 inclines at a predetermine angle θ with respect to the vertical (upward and downward directions in FIG. 5). In this state, the connection portion 34 extends in the vertical direction. That is, the connection portion 34 inclines at the same angle as the predetermined angle θ with respect to the flange portion 24. With the radiator 13 accommodated in the engine compartment 10, the rear wall 28 also extends vertically. As shown in FIG. 5, the front face of the inverter 14 accommodated in the engine compartment 10 extends in the vertical direction.

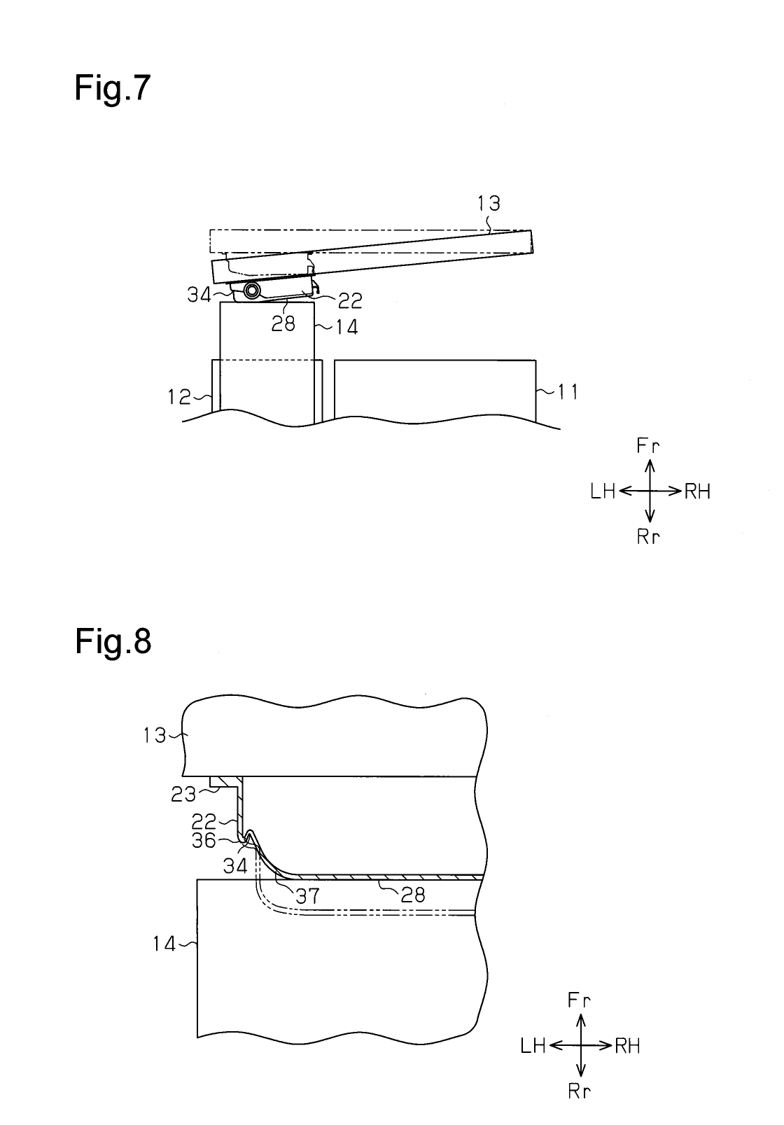

Operation of the radiator 13 of the present embodiment will now be described with reference to FIGS. 7 and 8.

As shown in FIG. 7, if the front left part of the vehicle is involved in a frontal collision, the radiator 13 rotates around the right-side portion of the radiator 13, as shown in FIG. 7, due to load applied from the front. Consequently, the left-side portion as viewed in FIG. 7 of the radiator 13 moves rearward. If the left-side portion as viewed in FIG. 7 of the radiator 13 moves rearward, the rear wall 28 of the reservoir tank 22 interferes with the inverter 14. Since the reservoir tank 22 interferes with the inverter 14, load is applied to the reservoir tank 22 also from behind by the reaction force of the inverter 14.

In the present embodiment, the reservoir tank 22 has the connection portion 34, which has a bent face. Therefore, if load in the longitudinal direction of the vehicle is applied to the reservoir tank 22 as a result of its interfering with the inverter 14, stress concentrates on the connection portion 34. The connection portion 34 functions as a weak portion, which is weaker against load in the longitudinal direction of the vehicle than the other portions of the radiator 13. Thus, the radiator 13 is easily compressed and deformed when load in the longitudinal direction of the vehicle is applied thereto, compared to the case where the radiator 13 lacks the connection portion 34. Therefore, as shown by the solid line in FIG. 8, if load in the longitudinal direction of the vehicle is applied to the reservoir tank 22, the connection portion 34 may be further bent or broken. Thus, the connection portion 34 is deformed to be dented into the front portion 32. As a result, the reservoir tank 22 is compressed and deformed to decrease in the dimension in the longitudinal direction of the vehicle. Since, in this way, impact is absorbed by the compression and deformation of the reservoir tank 22 in the event of collision, load transmitted to the inverter 14 via the radiator 13 is reduced.

Additionally, the radius of curvature of the connection portion 34 is smaller than the radii of curvature of the corners 36, 37 of the front and rear portions 32, 33. Therefore, when load in the longitudinal direction of the vehicle is applied to the reservoir tank 22, stress is liable to concentrate on the connection portion 34 with the smallest radius of curvature.

Additionally, the thickness of the connection portion 34 and the surrounding parts thereof is less than that of the other portions. Therefore, when load is applied, the surrounding parts of the connection portion 34 may easily be deformed.

Additionally, the connection portion 34 and the rear wall 28 extend vertically as viewed from the side. Therefore, if the front face of the inverter 14, which also extends vertically, interferes with the rear wall 28, most of the load acting in the longitudinal direction of the vehicle acts in the direction in which the reservoir tank 22 is compressed and deformed through the connection portion 34.

Since the inverter 14 is an electronic component, it is vulnerable to external impact compared to other components. In a case where an inverter 14 is located rearward of a radiator 13 in a hybrid vehicle that has, as sources of driving force, an internal combustion engine 11 and a motor 12, as with this vehicle, the inverter 14 may be deformed by its interfering with the radiator 13. If the inverter 14 is deformed in addition to the radiator 13, the inverter 14 also has to be replaced, increasing repair costs.

In this vehicle, the radiator 13, which is easily compressed and deformed when impact is applied to the vehicle from the front, is located forward of the inverter 14. This restrains deformation of the inverter 14, resulting from interference between the inverter 14 and the radiator 13. Since the reservoir tank 22 is provided on the rear portion of the radiator 13, the reservoir tank 22 is the first part liable to interfere with the inverter 14. The reservoir tank 22 is provided with the connection portion 34, thus more reliably reducing the load transmitted to the inverter 14.

Additionally, the radius of curvature of the corner 37 of the rear portion 33 of the reservoir tank 22 is large. Therefore, compared to a case where the corner 37 has a smaller radius of curvature and hence has a pointed shape, the contact pressure when the corner 37 interferes with the inverter 14 is reduced. This further restrains deformation of the inverter 14.

Furthermore, the rear wall 28 is provided with the inclined face 31 inclining such that this inclined face 31 is located further forward as the distance from the left side wall 29 decreases. Therefore, if the radiator 13 interferes with the inverter 14 while rotating due to load applied from the front left direction of the vehicle, the front face of the inverter 14 is liable to come into parallel contact with the rear wall 28 of the reservoir tank 22. Accordingly, contact pressure applied to the inverter 14 is further reduced.

The front right part of the vehicle may be involved in a frontal collision. In such a case, the radiator 13 rotates around the left portion of the radiator 13 due to load applied from front. Consequently the right portion of the radiator 13 moves rearward. In this vehicle, the reservoir tank 22 is located on the rear left of the radiator 13 such that the space between the radiator 13 and the internal combustion engine 11 is relatively large, whereas the space between the radiator 13 and the inverter 14 is relatively small. Therefore, even if the right portion of the radiator 13 moves rearward, collision between the radiator 13 and the internal combustion engine 11 is less likely to occur. Accordingly, interference between the radiator 13 and the internal combustion engine 11 is less likely to occur.

The first embodiment achieves the following advantages.

(1) The radiator 13 has the connection portion 34, which is weaker against load in the longitudinal direction of the vehicle than the other portions. Therefore, the radiator is easily compressed and deformed when load in the longitudinal direction of the vehicle is applied, compared to the case where the radiator 13 lacks the connection portion 34. Therefore, even if the radiator 13 moves in the rearward direction of the vehicle due to load applied from the front of the vehicle, and the inverter 14 consequently interferes with the radiator 13, load transmitted to the inverter 14 via the radiator 13 is reduced. This restrains deformation of the inverter 14, which is located rearward of the radiator 13.

(2) The connection portion 34 has a bent face. This bent face connects the front portion 32 and the rear portion 33 of the reservoir tank 22 such that there is a step between the front portion 32 and the rear portion 33. Since the weak portion is easily formed by this connection portion 34, the manufacture of the radiator 13 is facilitated.

(3) The radius of curvature of the connection portion 34 is smaller than the radii of curvature of the corners 36, 37 of the front and rear portions 32, 33. Therefore, when load in the longitudinal direction of the vehicle is applied to the radiator 13, stress is concentrated on the connection portion 34 with the smallest radius of curvature. Therefore, when load in the longitudinal direction of the vehicle is applied to the radiator 13, the connection portion 34 is easily deformed to bend further. Accordingly, compression and deformation is caused around the connection portion 34, thus making it possible to effectively absorb impact.

(4) Since the inverter 14 is located rearward of the radiator 13, the reservoir tank 22 is the first part liable to interference with the inverter 14. The reservoir tank 22 has the connection portion 34. Therefore, compressing and deforming the reservoir tank 22 more reliably reduces load transmitted to the inverter 14.

(5) Since deformation of the inverter 14 due to interference between the radiator 13 and this inverter is reduced, an increase in repair costs is restrained.

The first embodiment may be modified as follows.

In the first embodiment, the thickness of each of the corners 36, 37 of the front and rear portions 32, 33 becomes gradually thinner toward the connection portion 34. However, the thickness of each of the corners 36, 37 may become suddenly thin at a certain point thereof. That is, the surrounding parts of the connection portion 34 suffice as long as the surrounding parts are thinner than the other portions.

The connection portion 34 may be identical in thickness to the other portions. In this case also, the advantages (1) to (5) described above are obtained.

In the first embodiment, the upper wall 26, the lower wall 27, and the left side wall 29 each have the connection portion 34. However, the connection portion 34 may be provided at any one of the upper wall 26, the lower wall 27, and the left and right side walls 29, 30. In this case also, the advantages (1) to (5) described above are obtained.

### Second Embodiment

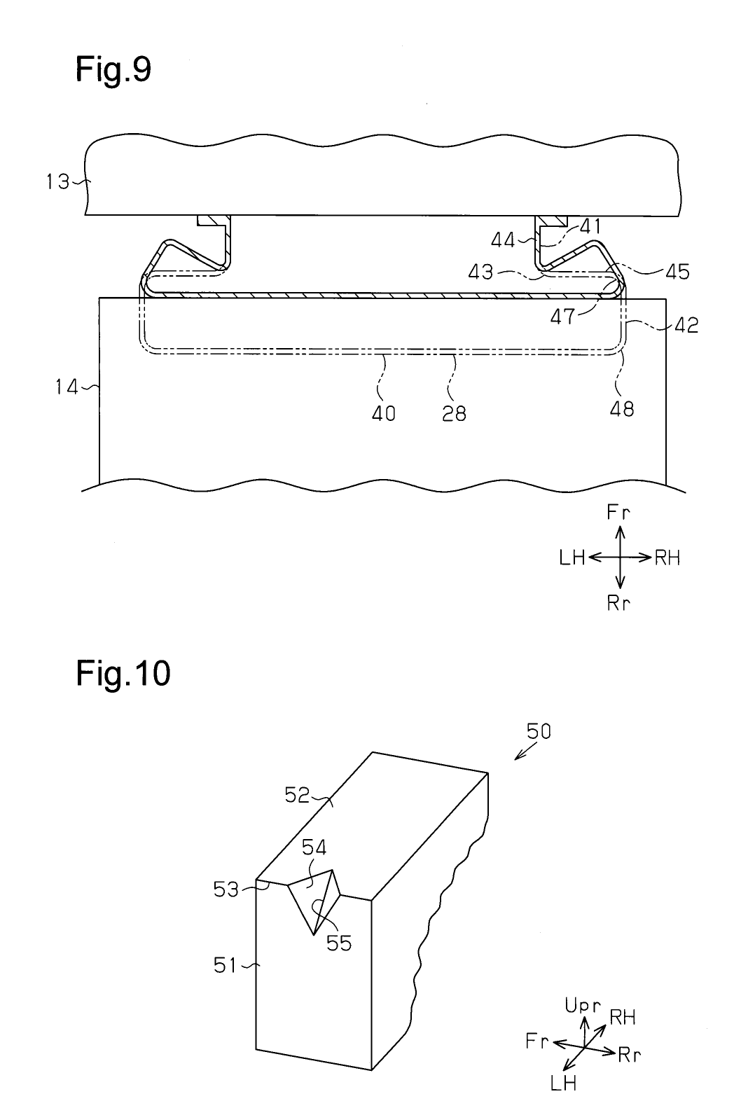

Next, a radiator 13 according to a second embodiment will be described with reference to FIG. 9. The radiator 13 according to the second embodiment differs from the first embodiment in the shape of the reservoir tank. The other components are labeled with identical signs to those in the first embodiment, and explanations thereof are omitted.

As indicated by the long dashed double-short dashed line in FIG. 9, each side wall of the reservoir tank 40 includes a connection portion 43, which has a bent face, a front portion 41 located forward of the connection portion 43, and a rear portion 42 located rearward of the connection portion 43. The connection portion 43, i.e., the bent face connects the front portion 41 and rear portion 42 such that there is a step between them. The connection portion 43 connects the side wall 44 of the front portion 41 to a face 45, which extends from the front end of the rear portion 42 toward the inside of the reservoir tank 40. In the reservoir tank 40, the front portion 41 is narrower than the rear portion 42 in the lateral direction of the vehicle.

The rear portion 42 has corners 47, 48 and is connected to the connection portion 43. The connection portion 43 is smaller in radius of curvature than the corner 47. Additionally, the rear corner 48 is smaller in radius of curvature than the front corner 47.

Therefore, if load in the longitudinal direction of the vehicle is applied to the reservoir tank 40 as a result of its interfering with the inverter 14 due to frontal collision of the vehicle, stress concentrates on the connection portion 43. The connection portion 43 functions as a weak portion, which is weaker against load in the longitudinal direction of the vehicle than the other portions. Thus, the radiator 13 is easily compressed and deformed when load in the longitudinal direction of the vehicle is applied thereto, compared to the case where the radiator 13 lacks the connection portion 43. Therefore, as shown by the solid line in FIG. 9, if load in the longitudinal direction of the vehicle is applied, the connection portion 43 may be bent further or broken. Thus, the connection portion 43 is deformed to be dented into the rear portion 42. As a result, the reservoir tank 40 is compressed and deformed to decrease in the dimension of the longitudinal direction of the vehicle. Since, in this way, impact is absorbed by the compression and deformation of the reservoir tank 40 in the event of collision, load transmitted to the inverter 14 via the radiator 13 is reduced.

Additionally, the radius of curvature of the corner 48 of the rear portion 42 of the reservoir tank 40 is large. Therefore, compared to a case where the corner 48 has a smaller radius of curvature and hence has a pointed shape, the contact pressure when the corner 48 interferes with the inverter 14 is reduced. Accordingly, deformation of the inverter 14 is further reduced.

Therefore, even in this case, the above described advantages (1) and (5) are achieved.

### Other Embodiments

The foregoing embodiments may be modified as follows.

In the first embodiment, the radius of curvature of the corner 37, which is provided in the rear portion 33 of the reservoir tank 22 and interferes with the inverter 14, is larger than that of the corner 36. Instead of this, the radius of curvature of the corner 37 may be smaller than that of the corner 36. Even in such a case, as long as the corner 37 has a relatively large radius of curvature and does not have a pointed shape, contact pressure when the corner 37 interferes with the inverter 14 is reduced.

Similarly, the radius of curvature of the corner 48 in the second embodiment may be smaller than that of the corner 47. Even in such a case also, as long as the corner 47 has a relatively large radius of curvature and does not have a pointed shape, contact pressure when the corner 47 interferes with the inverter 14 is reduced.

Each embodiment described above has the reservoir tank 22, 40 such that the flange portion 24 inclines at a predetermined angle 0 with respect to the vertical direction as viewed from the side. However, the reservoir tank 22, 40 may be provided without inclining the flange portion 24 with respect to the vertical direction. Even in such a case, it is preferable to provide the connection portions 34, 43 and the rear wall 28 in the vertical direction.

In the embodiments described above, the connection portions 34, 43 and the rear wall 28 are provided in the vertical direction. However, such a configuration may be omitted. That is, the connection portions 34, 43 and the rear wall 28 may be provided to be inclined with respect to the vertical direction. In this case also, the advantages (1) to (5) described above can be obtained.

In each of the embodiments, the vehicle has, as a source of driving force, a motor in addition to an internal combustion engine. However, the vehicle may have only an internal combustion engine as a source of driving force.

In each of the embodiments, a description is given using an example where the inverter 14 is provided rearward of the radiator 13. However, the advantages (1) to (4) are obtained even in a case where components other than the inverter 14 are provided rearward of the radiator 13.

In the embodiments described above, the reservoir tanks 22, 40 have the connection portions 34, 43, respectively. However, a part other than the reservoir tank, such as the upper tank 15 or lower tank 17 of the radiator 13 or the fan shroud 21, may have a connection portion. In this case also, the advantages (1) to (3) described above are obtained. Additionally, two or more of these parts may have a connection portion, for example, by respectively providing the reservoir tanks 22, 40 and the upper tank 15 with a connection portion.

In the first embodiment, the radius of curvature of the connection portion 34 is smaller than the radii of curvature of the corners 36, 37 of the front and rear portions 32, 33. However, as long as stress concentrates on the connection portion 34 and the connection portion functions as a weak portion, the radius of curvature of the connection portion 34 does not have to be the smallest. For example, the radius of curvature of either one of the corners 36, 37 may be smaller than that of the connection portion 34. Alternatively, the radius of curvature of either one of the corners 36, 37 may be equal to that of the connection portion 34, or the radii of curvature of the corners 36, 37 may be equal to the radius of curvature of the connection portion 34. In this case also, the advantages (1) and (2) described above are obtained.

Similarly, as long as stress concentrates on the connection portion 43 in the second embodiment and the connection portion functions as a weak portion, the radius of curvature of the connection portion 43 does not have to be smaller than that of the corner 47. For example, the radius of curvature of the corner 47 may be smaller than that of the connection portion 43, or the radius of curvature of the corner 47 may be equal to that of the connection portion 43.

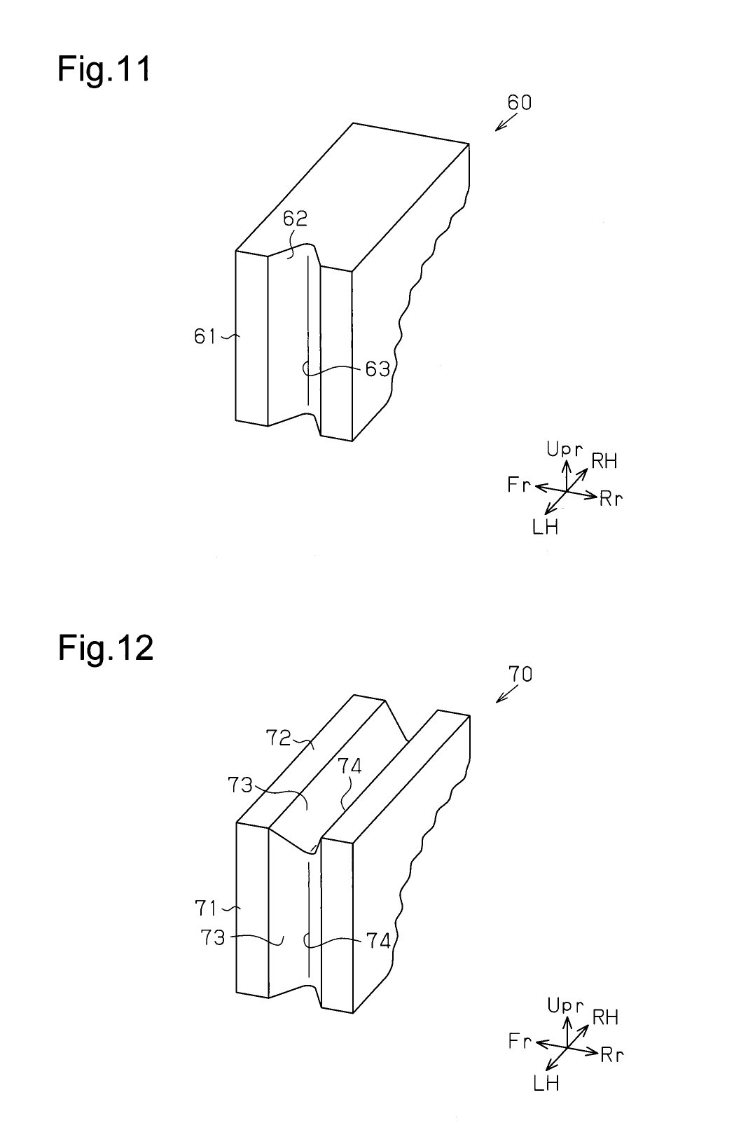

In the embodiments described above, the connection portions 34, 43, as weak portions, have bent faces configured to have a step between the front portions 32, 41 and the rear portions 33, 42, respectively. Instead of this, the configurations as shown in FIGS. 10, 11 may be employed.

As shown in FIG. 10, in a reservoir tank 50, a crush bead 54, as a recess, receding toward the inside of the reservoir tank 50 is formed at a corner 53 between a left side wall 51 and an upper wall 52. In this case, if load in the longitudinal direction is applied to the reservoir tank 50, stress concentrates on the base portion 55 of the crush bead 54. Consequently, this base portion 55 is further bent and the crush bead 54 is crushed, causing the reservoir tank 50 to be compressed and deformed. In the foregoing configuration, the crush bead 54 functions as a weak portion.

Additionally, as shown in FIG. 11, the crush bead 62 may be formed all the way along the entire length of the left side wall 61 of a reservoir tank 60. Alternatively, as shown in FIG. 12, a crush bead 73 may be formed all the way along the respective entire lengths of the left side wall 71 and upper wall 72 of a reservoir tank 70. In this case, if load in the longitudinal direction is applied to the reservoir tank 70, stress concentrates on the respective bottom portions 63, 74 of the crush beads 62, 73. Consequently, the bottom portions 63, 74 are bent further and the crush beads 62, 73 are crushed, causing the respective reservoir tanks 60, 70 to be compressed and deformed. In the foregoing configuration, each of crush beads 62, 73 functions as a weak portion.

Accordingly, the same advantage as the one described in (1) is obtained by the configurations shown in FIGS. 10 to 12. Of the upper wall, lower wall, and left and right side walls of a reservoir tank, crush beads may be formed all the way along the respective entire lengths of three or more walls. Alternatively, a crush bead may be formed in part of each wall.

What is claimed is:

1. A radiator accommodated in an engine compartment in a front part of a vehicle and configured to dissipate heat of coolant that has circulated in an internal combustion engine,
the radiator comprising a weak portion, which is weaker against load in a longitudinal direction of the vehicle than the other portions,
wherein the radiator is easily compressed and deformed when receiving load in the longitudinal direction of the vehicle compared to a case where the radiator lacks the weak portion.

2. The radiator according to claim 1, wherein
the radiator has, in the longitudinal direction of the vehicle, a first portion located forward of the weak portion and a second portion located rearward of the weak portion,
the weak portion has a bent face, and
the bent face connects the first portion and the second portion such that there is a step between the first and second portions.

3. The radiator according to claim 1, further comprising a reservoir tank for storing the coolant, wherein the reservoir tank has the weak portion.

4. A vehicle comprising:
the radiator according to claim 1;
a motor; and
an inverter for controlling the motor, wherein
the internal combustion engine and the motor are used as sources of driving force, and
the inverter is located rearward of the radiator in the engine compartment.
